(19) United States
(12) Patent Application Publication
(10) Pub. No.: US 2008/0249853 A1
(43) Pub. Date: Oct. 9, 2008

(54) ADVERTISING CAMPAIGN TEMPLATE

(76) Inventors: Elan Dekel, Herzliya (IL); Alex M. Cook, San Francisco, CA (US); Aaron Arcos, Zurich (CH)

Correspondence Address: FISH & RICHARDSON P.C., PO BOX 1022, MINNEAPOLIS, MN, 55440-1022, US

(21) Appl. No.: 11/697,197

(22) Filed: Apr. 5, 2007

(51) Int. Cl. G06Q 30/00

(52) U.S. Cl. 705/14; 700/117

(57) ABSTRACT

A system and technique is described for generating an advertising campaign based on an advertising campaign template. Template data is received from a first entity, the template data including advertising content and targeting criteria. An advertising campaign template is generated based on the template data and provided to a second entity. Customization data is provided by the second entity. An online advertising campaign is generated for the second entity based on the advertising campaign template and the customization data.

### TECHNICAL FIELD

This invention relates to an advertising system and technique.

### BACKGROUND

Interactive media (e.g., Internet-distributed content) has great potential for improving the targeting of advertisements (“ads”) to receptive audiences. For example, some websites provide information search functionality that is based on keywords entered by the user seeking information. This user query can be an indicator of the type of information of interest to the user. By comparing the user query to a list of keywords specified by, for example, an advertiser, it is possible to provide targeted ads to the user. An example of such a keyword-based advertising system is AdWords™ offered by Google, Inc. (Mountain View, Calif.).

Another form of online advertising is ad syndication, which allows advertisers to extend their marketing reach by distributing ads to additional partners. For example, third party online publishers can place an advertiser's text or image ads on web properties with desirable content to drive online customers to the advertiser's website. An example of such a site-based advertising system is AdSense™ offered by Google, Inc.

### SUMMARY

This invention relates to an advertising system and technique. In general, in one aspect, the invention features a computer implemented method for generating an online advertising campaign. Template data is received from a first user, the template data including advertising content and targeting criteria. An advertising campaign template is generated based on the template data and provided to a second user. Customization data is provided by the second user. An online advertising campaign is generated for the second user based on the advertising campaign template and the customization data.

Implementations of the invention can include one or more of the following features. The template data can further include budget information and/or bid information provided by the first user. The targeting criteria can include at least one of a keyword or a target web site address. The advertising content can include at least one of the following: text, a graphic, audio signals, video, executable software code, a digital photograph, or a hyperlink.

Where the online advertising campaign is a keyword based campaign, the template data can include multiple ad groups, where each ad group includes a bid amount, advertising content and targeting criteria being a set of one or more keywords. Where the online advertising campaign is a site based campaign, the template data can include multiple ad groups, each ad group including a bid amount, advertising content and targeting criteria being a set of one or more universal resource locators (URLs) for one or more web sites targeted for ad placement.

The advertising campaign template can further include one or more queries provided by the first user requesting specific customization data, and the customization data can include one or more responses provided by the second user to the one or more queries. The advertising campaign template can include a set of one or more rules provided by the first user defining limitations on modifications to the advertising content by the second user. A list identifying one or more users authorized to be provided the advertising campaign template can be provided by the first user, where the list includes an identification of the second user.

In general, in another aspect, the invention features a computer implemented method for generating an online advertising campaign template. Template data is received from a first entity at least partially defining an online advertising campaign, including advertising content and targeting criteria. An advertising campaign template is generated based on the template data. The advertising campaign template includes one or more data fields configured to receive customization data from a second entity.

Implementations of the invention can include one or more of the following features. The targeting criteria can include at least one of a keyword or a target web site address. The template data received from the first entity can further include budget information and/or bid information. The advertising content can include at least one of the following: text, a graphic, audio signals, video, a digital photograph, or a hyperlink.

Where the online advertising campaign is a keyword based campaign, the template data can include multiple ad groups, each ad group including a bid amount, advertising content and targeting criteria being a set of one or more keywords. Where the online advertising campaign is a site based campaign, the template data can include multiple ad groups, each ad group including a bid amount, advertising content and targeting criteria being a set of one or more universal resource locators (URLs) for one or more web sites targeted for ad placement.

The advertising campaign template can further include one or more queries provided by the first entity requesting specific customization data, and the customization data can include one or more responses provided by the second entity to the one or more queries. The advertising campaign template can include a set of one or more rules provided by the first entity defining limitations on modifications to the advertising content by the second entity. A list identifying one or more entities authorized to be provided the advertising campaign template, the list including an identification of the second entity, can be provided by the first entity.

In general, in another aspect, the invention features a computer implemented method for generating an online advertising campaign for a second entity using an advertising campaign template generated by a first entity. An advertising campaign template including advertising content and targeting criteria is provided to the second entity. Customization data is received from the second entity relevant to the second entity, for whom the online advertising campaign is being generated. An online advertising campaign generated based on the advertising campaign template and the customization data is provided to the second entity.

Implementations of the invention can include one or more of the following features. The targeting criteria can include at least one of a keyword or a target web site address. The advertising campaign template can further include budget information and/or bid information. The advertising content can include at least one of the following: text, a graphic, audio signals, video, executable software code, a digital photograph, or a hyperlink.

Where the online advertising campaign is a keyword based campaign, the template data can include multiple ad groups, each ad group including a bid amount, advertising content and targeting criteria being a set of one or more keywords. Where the online advertising campaign is a site based campaign, the template data can include multiple ad groups, each ad group including a bid amount, advertising content and targeting criteria being a set of one or more universal resource locators (URLs) for one or more web sites targeted for ad placement. The advertising campaign template can further include a set of one or more rules provided by the first entity defining limitations on modifications to the advertising content by the second entity.

In general, in one aspect, the invention features a system for generating an online advertising campaign. The system includes a user interface configured to receive template data from a first user, the template data including advertising content and targeting criteria. The system further includes means for providing the advertising campaign template to a second user, and means for receiving customization data from the second user, the customization data including information specific to the online advertising campaign being generated. The system also includes means for generating an advertising campaign template based on the template data, and for generating an online advertising campaign for the second user based on the advertising campaign template and the customization data.

Implementations of the invention can include one or more of the following features. The targeting criteria can include at least one of a keyword or a target web site address. The template data can further include budget and/or bid information. The advertising content can include at least one of the following: text, a graphic, audio signals, video, a digital photograph or a hyperlink.

Where the online advertising campaign is a keyword based campaign, the template data can include multiple ad groups, each ad group including a bid amount, advertising content and targeting criteria being a set of one or more keywords. Where the online advertising campaign is a site based campaign, the template data can include multiple ad groups, each ad group including a bid amount, advertising content and targeting criteria being a set of one or more universal resource locators (URLs) for one or more web sites targeted for ad placement. The advertising campaign template can further include a set of one or more rules provided by the first user defining limitations on modifications to the advertising content by the second user. The user interface can be further configured to receive a list identifying one or more users authorized to be provided the advertising campaign template, the list including an identification of the second user.

Implementations of the invention can realize none, one or more of the following advantages. The experience and know-how of one entity in executing a successful advertising campaign can be easily imparted to a second entity by way of an advertising campaign template. A parent organization can have some assurance that children organizations are executing successful advertising campaigns within policies implemented by the parent organization and according to the parent organization's best practices. An entity with little or no experience in generating an advertising campaign can easily customize an advertising campaign template and initiate the entity's own advertising campaign in an efficient and effective manner.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example online advertising system.

FIG. 2 is an example of an interface to a search engine displaying search results and ads.

FIG. 3 is a flowchart showing an example process for generating an advertising campaign template and an advertising campaign therefrom.

FIG. 4 is an example of a user interface for viewing a list of advertising campaign templates in a template library.

FIG. 5 is an example of a user interface for inputting template data.

FIG. 6 is a flowchart showing an example process for generating an advertising campaign from an advertising campaign template.

FIG. 7 is an example of a user interface for inputting customization data.

FIG. 8 is a schematic diagram of an example computer system.

Like reference symbols in the various drawings indicate like elements.

### DETAILED DESCRIPTION

Techniques and a system for advertising is described. In some implementations, the techniques and system can be used to facilitate online advertising, being advertising occurring over a network including one or more local area networks (LANs) or a wide area network (WAN), for example, the Internet. Any reference herein to “online advertising” is meant to include any such advertising occurring over a network and is not limited to advertising over the Internet. Further, the techniques and system described can be used to distribute content over other distribution media (e.g., not online), including those over broadcast, wireless, radio or other distribution networks. By way of example, the techniques and system are discussed in an on-line advertising context, but other contexts are possible.

Conducting a successful online advertising campaign can be facilitated with the benefit of institutional knowledge such as knowledge and/or experience as to effective ad content, ad placement and ad pricing. Ad content can include text, graphics, animation, audio, video, software code or scripts (such as Javascript, Adobe Flash, or other executable code), links and/or other information that is provided to the target audience when the ad is displayed.

Ad placement involves deciding where, when or under what circumstances the ad should be displayed. Targeting criteria can be used to define the ad placement. For example, for a keyword-based advertising campaign, the targeting criteria can include one or more keywords that trigger the ad being provided to a potential audience by placement on a webpage, for example, a search engine's search results webpage. As another example, for a site-based advertising campaign, the targeting criteria can include a list of one or more URLs (Universal Resource Locators) of target websites on which to place an ad (sometimes referred to as a “white list”). Another example is to include a black list of URLs in the targeting criteria, being a list of websites on which the ad is never to be placed. In another example, an advertising system crawls web pages and generates a set of keywords relevant to the content included in the web page. The advertising system then matches ads included in an ad inventory with the web pages based on said relevant keywords and keywords associated with the ads, where the keywords associated with the ads are included in the targeting criteria for said ad. Other types of targeting criteria can be used, and the ones described are but examples.

Ad pricing can vary for many reasons, some of which depend on the publisher of the ad. In some online advertising systems, advertisers pay for their ads on a Cost-Per-Click (CPC) basis. A common way for advertisers to set a CPC is to take a target Cost-Per-Action (CPA) and multiple it by an average Click-Through-Rate (CTR) on a keyword. CPA is an online advertising Return-On-Investment (ROI) metric in which return is based solely on qualifying actions, such as a sale or registration, as measured against the marketing costs associated with reaching that sale or registration. Ad pricing may also be on a cost per impression basis, meaning a cost is incurred each time the ad is displayed.

An advertiser can specify a maximum monetary value the advertiser is willing to pay for an action or impression, the maximum monetary value being the advertiser's “bid”. If ads from multiple advertisers can be displayed at one time, the order or relative placement of the ads can depend on the relative bids placed by each advertiser. An advertiser can set a budget, e.g., a monthly budget, with respect to a certain ad, such that once the budget has been expended due to a certain number of actions or impressions of the ad occurring, the ad is no longer displayed. If the budget is monthly, then the ad may remain dormant until the next month begins, or alternatively, the advertiser can choose to increase the budget.

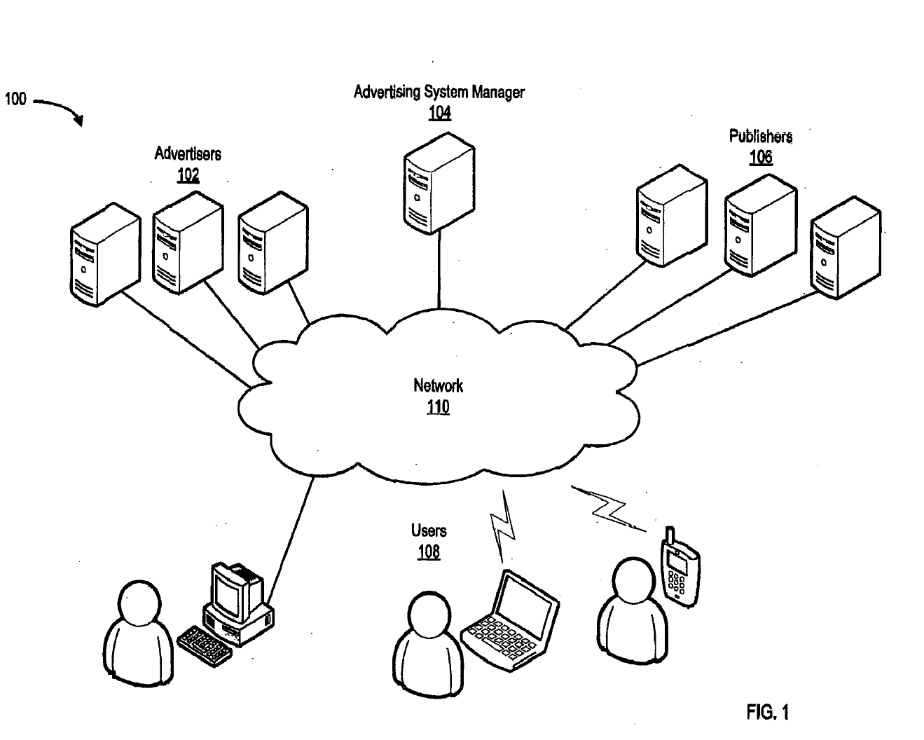

FIG. 1 is a block diagram of an implementation of an online advertising system 100. In some implementations, one or more advertisers 102 can directly, or indirectly, enter, maintain, and track advertisement information in an advertising management system 104. The ads may be in the form of graphical ads, such as banner ads, text only ads, image ads, audio ads, video ads, ads combining one or more of any of such components, etc. The ads may also include embedded information, such as a links, meta-information, and/or machine executable instructions. One or more publishers 106 may submit requests for ads to the system 104. The system 104 responds by sending ads or information that will allow for the retrieval of ads to the requesting publisher 106 for placement/serving on one or more of the publisher's web properties (e.g., websites and other network-distributed content). In some embodiments, publisher's properties available in this system may also include both Internet-distributed and broadcast distributed content such as, but not limited to, television spots, radio spots, print advertising, billboard advertising (electronic or printed), on-vehicle advertising, and the like.

Other entities, such as users 108 and the advertisers 102, can provide usage information to the system 104, such as, for example, whether or not a conversion or click-through related to an ad has occurred. This usage information can include measured or observed user behavior related to ads that have been served. The system 104 performs financial transactions, such as crediting the publishers 106 and charging the advertisers 102 based on the usage information. A computer network 110, such as a local area network (LAN), wide area network (WAN), the Internet, or a combination thereof, connects the advertisers 102, the system 104, the publishers 106, and the users 108.

One example of a publisher 106 is a general content server that receives requests for content (e.g., articles, electronic mail messages, discussion threads, music, video, graphics, networked games, search results, web page listings, information feeds, dynamic web page content, etc.), and retrieves the requested content in response to the request. The content server may submit a request for ads to an ad server in the system 104. The ad request may include a number of ads desired. The ad request may also include content request information. This information can include the content itself (e.g., page or other content document), a category or keyword corresponding to the content or the content request (e.g., arts, business, computers, arts-movies, arts-music, etc.), part or all of the content request, content age, content type (e.g., text, graphics, video, audio, mixed media, etc.), geo-location information, demographic information related to the content, keyword, web property, etc., and the like.

In some implementations, the content server can combine the requested content with one or more of the ads provided by the system 104. The combination can happen prior to delivery of the content to the user or contemporaneously where the advertising server can serve the ads directly to an end user. The combined content and ads can be delivered to the user 108 that requested the content for presentation in a viewer (e.g., a browser or other content display system). The content server can transmit information about the ads back to the ad server, including information describing how, when, and/or where the ads are to be rendered (e.g., in HTML or JavaScript™).

In another example, the publisher 106 is a search service. A search service can receive queries for search results. In response, the search service can retrieve relevant search results from an index of content (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number may depend on the search results, the amount of screen or page space occupied by the search results, the size and shape of the ads, etc. In some implementations, the number of desired ads will be from one to ten, or from three to five.

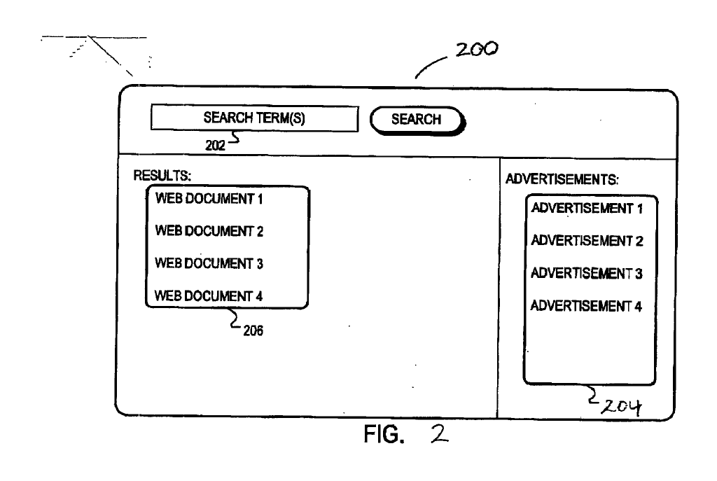

The search service can combine the search results with one or more of the ads provided by the system 104. This combined information can then forwarded to the user 108 that requested the content. The search results can be maintained as distinct from the ads, so as not to confuse the user between paid advertisements and presumably neutral search results. For example, FIG. 2 shows one implementation of a search service web page 200 combining search results 206 from a search query 202 with ads 204. The order in which the ads 204 are displayed can be determined by the bid values of each corresponding advertiser. In the example shown, the higher the bid, the higher (e.g., relatively) on the list the ad is displayed. In the example shown, four different ads are displayed representing, for example, the top four bids for ad placement on the web page 200.

Referring again to FIG. 1, the search service can transmit information about the ad and when, where, and/or how the ad was to be rendered back to the system 104. As can be appreciated from the foregoing, the advertising management system 104 can serve publishers 106, such as content servers and search services. The system 104 permits serving of ads targeted to content (e.g., documents, web pages, web blogs, etc.) served by content servers. For example, a network or inter-network may include an ad server serving targeted ads in response to requests from a search service with ad spots for sale. Suppose that the inter-network is the World Wide Web. The search service can be configured to crawl much or all of the content. Some of this content will include ad spots (also referred to as “inventory”) available. In this example, one or more content servers may include one or more documents. Documents may include web pages, email, content, embedded information (e.g., embedded media), meta-information and machine executable instructions, and ad spots available. The ads inserted into ad spots in a document can vary each time the document is served or, alternatively, can have a static association with a given document.

Decisions as to the bid value, budget amount, the ad content and the targeting criteria can have a significant impact on the success or failure of an online advertising campaign. Accordingly, as may be expected, entities experienced in running online advertising campaigns acquire valuable know-how as to creating a successful online advertising campaign.

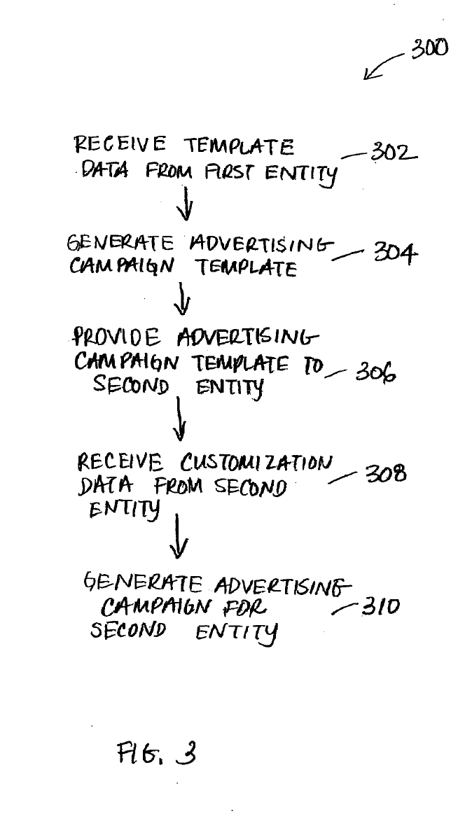

A technique and system is described for facilitating the generation of an online advertising campaign. Referring to FIG. 3, an example process 300 for generating an advertising campaign template for use in generating an online advertising campaign is shown. A first entity provides template data including advertising content and targeting criteria (Step 302). In one implementation, the targeting criteria includes at least one of either a keyword (for a keyword based campaign) or a target web site address (for a site based campaign). Optionally, the first entity can provide bid information. The first entity may be an entity experienced in creating online advertising campaigns. An advertising campaign template is generated based on the template data provided by the first entity (Step 304). The advertising campaign template is provided to a second entity (Step 306). The second entity may be an entity that has little or no experience in generating online advertising campaigns or one that is limited in its capabilities/desire to exercise control over such. The second entity provides customization data (Step 308). By way of illustrative example, the customization data can include a URL for a webpage linked to an ad (e.g., a landing page) placed in accordance with the online advertising campaign. An online advertising campaign for the second entity is generated based on the advertising campaign template and the customization data (Step 310).

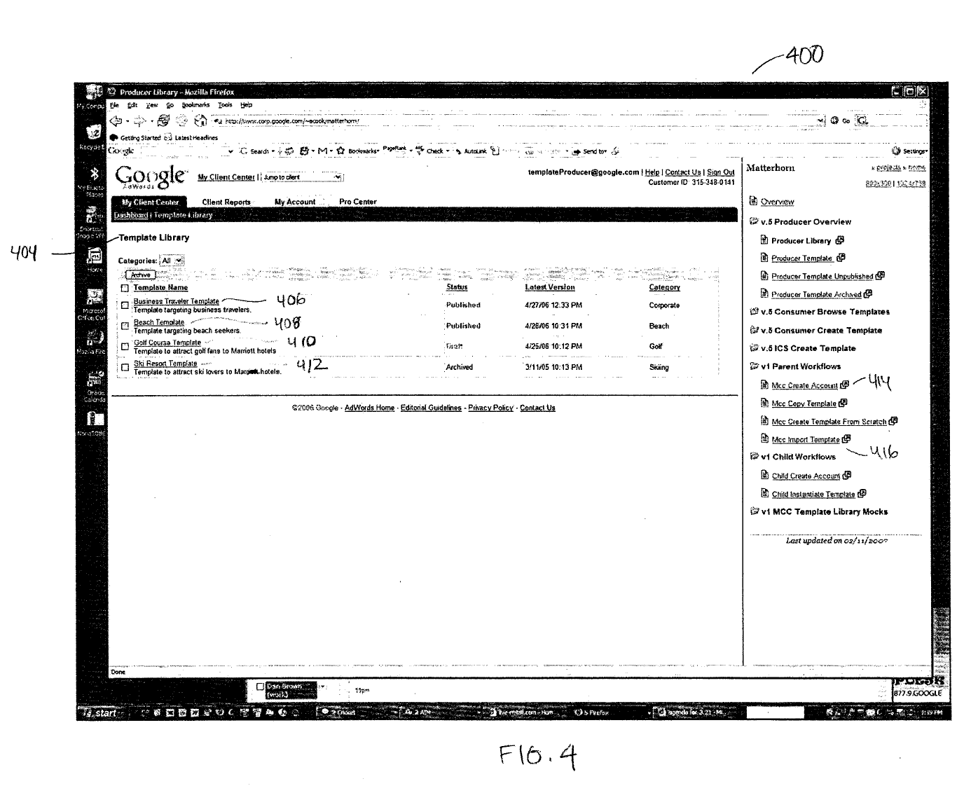

Referring now to FIGS. 4, 5 and 7, an example to illustrate some advantageous features of generating online advertising campaigns based on advertising campaign templates shall be described. In this illustrative example, the first entity, which creates the advertising campaign template, is a parent organization in the hotel industry, such as a hotel franchiser for the fictitious hotel chain “Mar Hotel”. The second entity is child organization, for example, a hotel franchisee.

FIG. 4 shows an example of a user interface 400 that can be used to implement the technique of generating an online advertising campaign template as described herein, although it should be understood that other configurations of user interfaces can be used. The parent organization is provided a list of the advertising campaign templates included in its Template Library 404. The Template Library 404 includes advertising campaign templates previously created (or at least partially created) by the parent organization, or otherwise obtained by or made accessible to the parent organization. In one implementation, the parent organization can import advertising campaign templates into the Template Library 404, for example, created by a third party specializing in online advertising. If the parent organization has not generated any advertising campaign templates, then the Template Library 404 will be empty and the parent organization can choose to create or import a new template by activating the “Create Template” or “Import Template” links 414 and 416 respectively.

In this example, the Template Library 404 includes four advertising campaign templates, each directed to a different type of hotel or target audience: the business traveler template 406, the beach template 408, the golf course template 410 and the ski resort template 412. In this example, the names of the template are descriptive of the type of hotel that would benefit from an advertising campaign generated from the advertising campaign template. That is, the business traveler template 406 may be useful for hotels located in the business district of a city, the beach template 408 may be useful for hotels located near a beach, the golf course template 410 may be useful for hotels located on or near a golf course and the ski resort template 412 may be useful for hotels located at or near a ski resort.

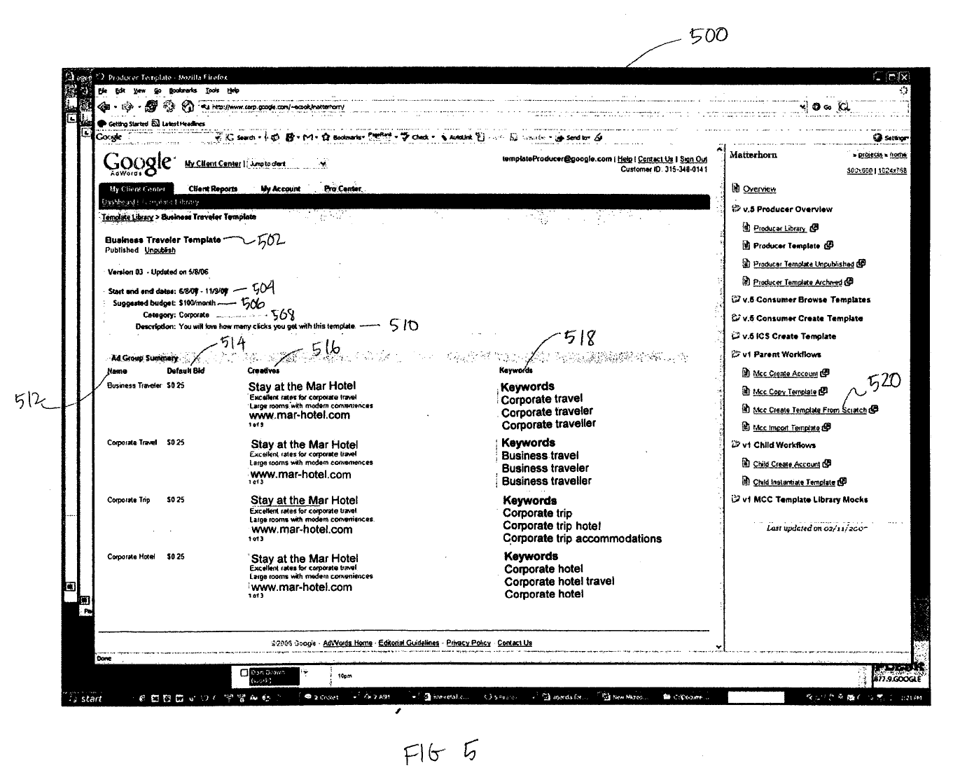

If the business traveler template 406 is selected, for example, by double-clicking on the “Business Traveler Template” hyperlink, then the parent organization is directed to a web page illustrated by the example user interface 500 shown in FIG. 5. The template data previously input by the parent organization to generate the business traveler template 406 is shown. In this implementation, the template data includes:

template name 502;

start and end dates 504;

suggested budget 506;

category 508;

description 510; and

for each AdGroup (defined below), a name 512, default bid 514, creative 516 and keyword(s) 518.

In one implementation, the template data is input by the parent organization filling in data fields in an interface configured such as the user interface 500 shown. However, in another implementation, the parent organization can receive a series of prompts for the template data, which can be accompanied by hints as to the type of information to provide, thereby guiding the parent organization through the process of inputting the template data.

Referring again to FIG. 5, in this example, the template name 502 can be descriptive of the type of child organization that may benefit from using the advertising campaign template. The start and end dates 504 provide a time period over which the advertising campaign template can be made available to one or more child organizations. For example, if the ad content relates to a seasonal advertising campaign, then the time period may restrict use of the advertising campaign template to the relevant season. In another implementation, the start and end dates can be suggested or fixed start and end dates for the child organization to run an advertising campaign generated using the advertising campaign template.

The suggested budget 506, which in this example is expressed as a dollar amount per month, is the budget the parent organization suggests the child organization provide to an advertising campaign generated using the selected advertising campaign template. In one implementation, the parent organization can fix the budget, and therefore the child organization must use the budget set by the parent organization if using the template to generate an advertising campaign. In another implementation, the budget is suggested (as in this example), but can be modified by the child organization, or alternatively, no budget information is included in the advertising campaign template.

The category 508 can be used to identify a category of target audience an advertising campaign generated using the advertising campaign template can be directed toward. In this example, the category identified is “corporate” meaning the corporate sector can be targeted using this advertising campaign template.

The description 510 can be used to include any additional information the parent organization wants to convey to a child organization using the advertising campaign template. In this example, the parent organization has provided an encouraging message to the child organization that they will love how many clicks they get using this template.

A simple advertising campaign template can include one default bid 514 (optional), one creative 516 and targeting criteria, e.g., one set of keywords 518 (“creative” is another term that can be used to describe the ad content). For example, for the keywords shown in the first row of the keywords 518 column, i.e., corporate travel, corporate traveler and corporate traveller, the default bid 514 is $0.25 and the creative 516 is a textual ad including a hyperlink to a web page (which can be customized by the second entity, as described below). Thus, for a keyword based advertising campaign generated using this template, if a user entered the search term “corporate travel” into a search engine, an ad including the creative 516 may be displayed along with the search results, if the default bid $0.25 is sufficient to “win” an ad placement on the search engine's search results web page.

The business traveler template 406 shown is not a simple advertising campaign as described above, but rather includes more than one “AdGroup”, where an AdGroup refers to a group including a bid, creative (i.e., ad content) and targeting criteria, in this example, a set of one or more keywords. The AdGroup can be given a name 512. In this example, there are four AdGroups having the following names: business traveler, corporate travel, corporate trip and corporate hotel. Each AdGroup has the same bid 514 and creative 516, however, in another implementation, the bid 514 and/or creative 516 can be different from one AdGroup to the next. Including more than one AdGroup can increase the scope of an advertising campaign generated from the advertising campaign template. A wider range of keywords can be used to trigger an ad placement, and some flexibility in bids and creatives can be employed, by varying the bids and creatives as between the AdGroups.

The user interface 500 shown can also be used by the parent organization to edit an existing advertising campaign template. If the parent organization wants to generate a new advertising campaign template, the “Create Template” link 520 can be activated and a user interface similar to the one shown can be presented to the parent organization with the data fields blank. The parent organization can complete the data fields and thereby provide the template data. Other configurations of user interfaces and techniques for obtaining the template data can be used, and the ones shown and described are illustrative examples.

Once the parent organization has input the template data, the advertising campaign template, e.g., the business travel template 406, is generated. The parent organization can specify one or more child organizations that can be given access to the advertising campaign template.

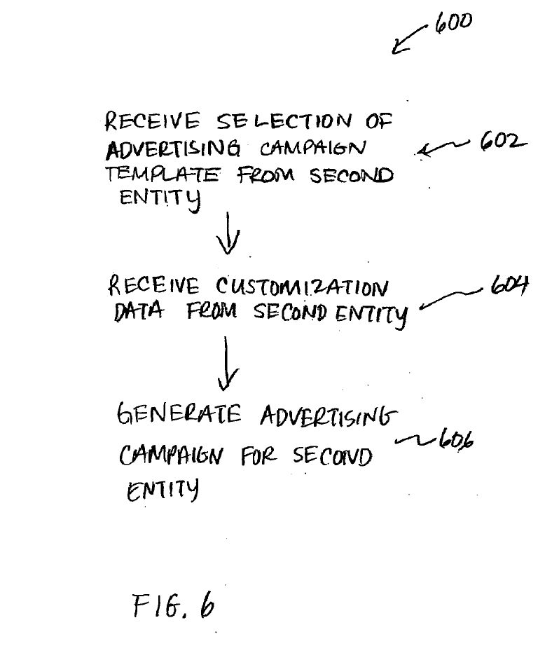

Referring to FIG. 6, a process 600 for generating an online advertising campaign using an advertising campaign template is shown. By way of illustrative example, consider a child organization that would like to generate an online advertising campaign targeted to a corporate audience for business travel. The child organization can select an appropriate advertising campaign template from a list of advertising campaign templates the child organization may access (Step 602). In this example, the child organization is a franchisee of the Mar-Hotel franchisor and has access to all of the advertising campaign templates included in the parent organization's Template Library 404. The child organization selects the business traveler template 406.

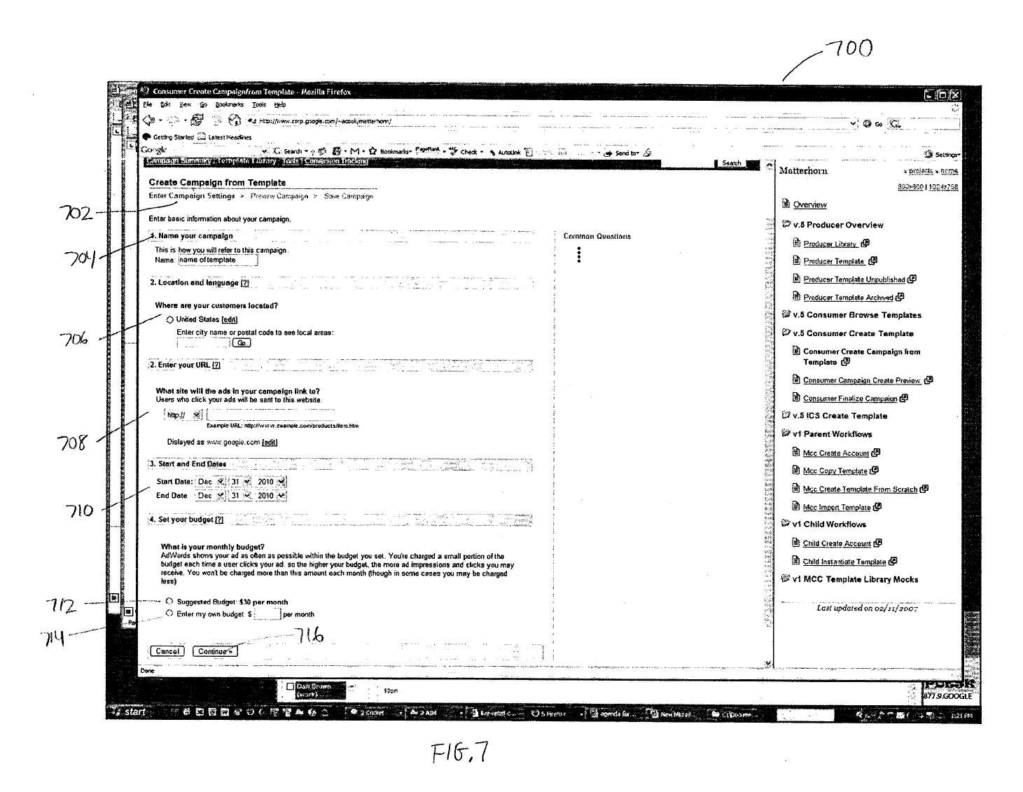

Referring to FIG. 7, in response to selecting the business travel template 406 the child organization can be directed to the example user interface 700 shown, which prompts the child organization to input customization data, referred to as “campaign settings” 702 (Step 604). The customization data requested from the child organization can vary from one implementation to the next, and the customization data shown as requested in the user interface 700 is one illustrative example. In this example, the child organization is requested to input a name 704 for the advertising campaign that will be generated from the selected advertising campaign template. The child organization is asked to input the location 706 where the child organization's customers are located. For example, for a hotel located in the financial district of San Francisco, Calif., the child organization can input United States. In another implementation, a more detailed location, e.g., a state or city name, can be requested.

The child organization is asked to input the URL 708 of the web site to which the ads included in the advertising campaign will be linked. For example, the child organization's URL may be www.mar-hotel-san-francisco.com. The child organization is asked to input start and end dates 710 for the advertising campaign. In some implementations, the advertising campaign will run between the start and end dates 710 or until the budget is reached, whichever shall occur first.

In this implementation, the child organization is asked to input their monthly budget for the advertising campaign. The budget suggested by the parent organization, that is, the suggested budget 712 of $30 per month, is shown and can be selected by the child organization. Alternatively, in some implementations the child organization can input their own budget 714, being a different amount that is either lower or higher than the suggested budget.

Once the child organization has input the requested customization data, the advertising campaign is generated based on the advertising campaign template 406 and the customization data 704-714 (Step 606). In one implementation, by selecting the “continue” button shown at the bottom of the user interface 700 the child organization is provided a preview of the advertising campaign. A user interface to provide the advertising campaign preview can look similar to the user interface 500 shown in FIG. 5 discussed above, although, the user interface can be configured differently and this is just one example. Once the child organization's advertising campaign is generated, the advertising campaign can begin (e.g., made available for being served by an advertising system such as one described above with respect to FIG. 1) according to the start date selected by the child organization.

In the example described above, the advertising campaign template is directed to generating a keyword based advertising campaign, that is, the targeting criteria is a set of one or more keywords. However, as discussed previously, an advertising campaign template can be used to generate an advertising campaign based on any type or combination of types of targeting criteria. By way of example, in the case of a site based advertising campaign, the targeting criteria included in the template data input by the parent organization includes one or more URLs for web sites on which the ads included in the advertising campaign are to be placed, rather than a set of keywords. In some embodiments, the child organization may target certain geolocation, demographic, or content keyword demographics. This targeting criteria may be entered by or limited in scope by the parent organization, or it may be entered by the child organization. Multiple child organizations may overlap in targeting criteria or may have distinct targeting criteria, as limited or allowed by the parent organization.

In one implementation, the template data can include a set of one or more questions provided by the parent organization to request certain customization information from the child organization. For example, the parent organization may include the following question in the template data: What is the nearest landmark to your location? The ad content may include a field to input the name of the nearest landmark, as provided by the child organization. For example, when providing the customization data, the child organization may respond to the question with the answer “Golden Gate Bridge”. The ad content may include a statement “Near the famous [nearest landmark data field]!”, which would then read in the child organization's customized ad as “Near the famous Golden Gate Bridge!”. One such system for creating a question template for a party to enter data is described in U.S. patent application Ser. No. 11/463,454, entitled “System and Method for Generating Creatives”, filed by Stanis, et al on Aug. 9, 2006, and assigned to the assignee of the present application and which is hereby incorporated by reference in its entirety.

In another implementation, the parent organization can implement controls on permissible modifications to the ad content, for example, to exert control over how a licensed trademark is used. By way of illustrative example, the parent organization owns the trademark MAR HOTEL and licenses use of the trademark to the child organization. The license agreement states that the trademark cannot be abbreviated as MH, and must always be used in full as MAR HOTEL. The parent organization can include the trademark MAR HOTEL in the ad content and implement a rule that the ad content cannot be modified to include the letters MH in combination. As another example, the primary competitor of Mar Hotel is Trip Hotel. The parent organization can implement a control that the ad content cannot be modified to include the term “Trip Hotel”, thereby avoiding the risk of a child organization including potentially defamatory language about a competitor within the ad content. Other forms of controls over the ad content are possible, and the ones discussed are merely examples.

As previously discussed, the parent organization can provide a suggested budget, a fixed budget or no budget. The parent organization can provide a default bid, a fixed bid, a suggested bid or no bid.

The above examples were described in the context of parent and child organizations. However, as previously mentioned, the first entity creating the advertising campaign template and the second entity accessing and using the advertising campaign template to generate an advertising campaign do not have to have a parent/child relationship. For example, the first entity can be an advertising specialist and the second entity can be a purchaser or licensee of the advertising campaign template. In another example, the first entity is a trademark owner and licensor and the second entity is a licensee of the trademark. As also discussed above, although the examples provided herein relate to an online advertising campaign, the techniques and systems described are not limited to online advertising.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

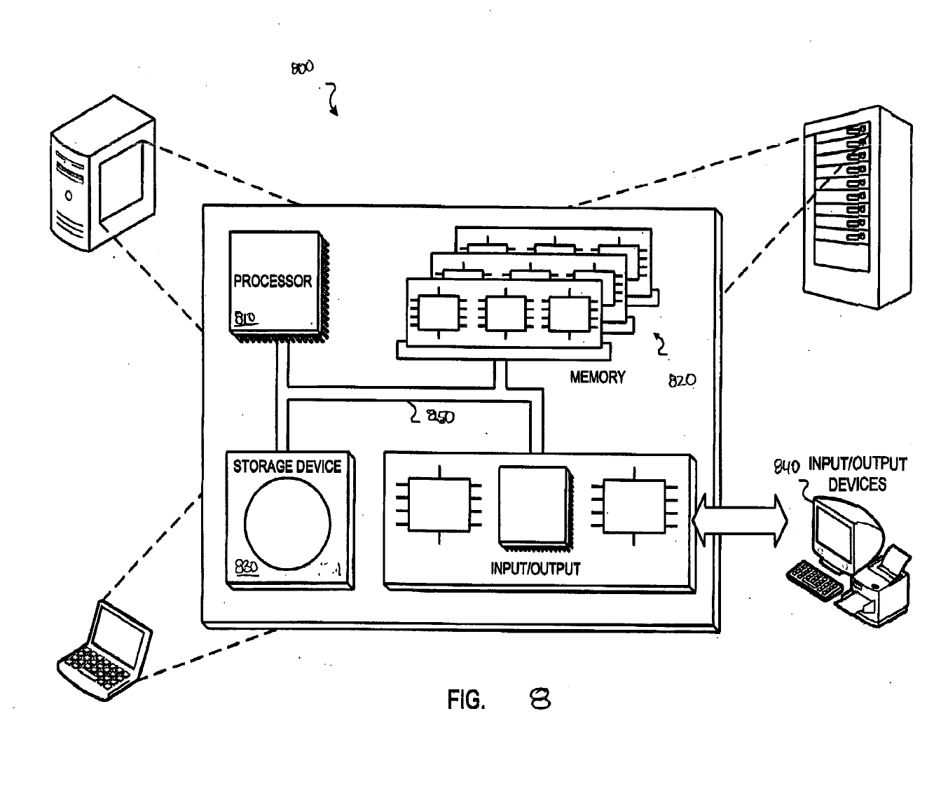

Referring now to FIG. 8, a schematic diagram of an example computer system 800 is shown. The system 800 can be used for the operations described in association with the processes 300 and 600 shown in FIGS. 3 and 6, according to one implementation. For example, one or more of the systems 800 can be used to implement a server hosting the advertising system manager 104, an advertiser 102, a publisher 106 and/or a user 108 (see FIG. 1).

The system 800 includes a processor 810, a memory 820, a storage device 830, and an input/output device 840. Each of the components 810, 820, 830, and 840 can, for example, be interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840. In some embodiments, a parallel processing set of systems 800 connected over a network may be employed, clustered into one or more server centers.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 includes a keyboard and/or pointing device. In another implementation, the input/output device 840 includes a display unit for displaying graphical user interfaces.

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method for generating an online advertising campaign, comprising:
receiving template data from a first user, the template data including advertising content and targeting criteria;
generating an advertising campaign template based on the template data;
providing the advertising campaign template to a second user;
receiving customization data from the second user; and
generating an online advertising campaign for the second user based on the advertising campaign template and the customization data.

2. The method of claim 1, wherein receiving template data from a first user further comprises receiving bid information.

3. The method of claim 1, wherein the targeting criteria comprises at least one of a keyword or a target web site address.

4. The method of claim 1, where the advertising content comprises at least one of the following: text, a graphic, audio signals, video, executable software code, a digital photograph, or a hyperlink.

5. The method of claim 1, where the online advertising campaign is a keyword based campaign and the template data includes a plurality of ad groups, each ad group including a bid amount, advertising content and targeting criteria comprising a set of one or more keywords.

6. The method of claim 1, where the online advertising campaign is a site based campaign and the template data includes a plurality of ad groups, each ad group including a bid amount, advertising content and targeting criteria comprising a set of one or more universal resource locators (URLs) for one or more web sites targeted for ad placement.

7. The method of claim 1, where:
the advertising campaign template further comprises one or more queries provided by the first user requesting specific customization data; and
the customization data includes one or more responses to the one or more queries provided by the first user.

8. The method of claim 1, where:
the advertising campaign template further comprises a set of one or more rules provided by the first user defining limitations on modifications to the advertising content by the second user.

9. The method of claim 1, further comprising:
receiving a list identifying one or more users authorized to be provided the advertising campaign template, the list including an identification of the second user.

10. The method of claim 1, where the template data further includes budget information.

11. A computer implemented method for generating an online advertising campaign template, comprising:
receiving template data from a first entity at least partially defining an online advertising campaign, including advertising content and targeting criteria; and
generating an advertising campaign template based on the template data, the advertising campaign template including one or more data fields configured to receive customization data from a second entity.

12. The method of claim 11, wherein the targeting criteria includes at least one of a keyword or a target web site address.

13. The method of claim 11, where receiving template data from a first entity further comprises receiving bid information.

14. The method of claim 11, where the advertising content comprises at least one of the following: text, a graphic, audio signals, video, a digital photograph, or a hyperlink.

15. The method of claim 11, where the online advertising campaign is a keyword based campaign and the template data includes a plurality of ad groups, each ad group including a bid amount, advertising content and targeting criteria comprising a set of one or more keywords.

16. The method of claim 11, where the online advertising campaign is a site based campaign and the template data includes a plurality of ad groups, each ad group including a bid amount, advertising content and targeting criteria comprising a set of one or more universal resource locators (URLs) for one or more web sites targeted for ad placement.

17. The method of claim 11 where:
the advertising campaign template further comprises one or more queries provided by the first entity requesting specific customization data; and
the customization data includes one or more responses to the one or more queries provided by the first entity.

18. The method of claim 11, where:
the advertising campaign template further comprises a set of one or more rules provided by the first entity defining limitations on modifications to the advertising content by the second entity.

19. The method of claim 11, further comprising:
receiving a list identifying one or more entities authorized to be provided the advertising campaign template, the list including an identification of the second entity.

20. The method of claim 11, where the template data further includes budget information.

21. A computer implemented method for generating an online advertising campaign for second entity using an advertising campaign template generated by a first entity, comprising:
providing the advertising campaign template including advertising content and targeting criteria to the second entity;
receiving customization data from the second entity relevant to the second entity for whom the online advertising campaign is being generated; and
providing an online advertising campaign generated based on the advertising campaign template and the customization data to the second entity.

22. The method of claim 21, where the targeting criteria comprises at least one of a keyword or a target web site address.

23. The method of claim 21, where the advertising campaign template further comprises bid information.

24. The method of claim 21, where the advertising content comprises at least one of the following: text, a graphic, audio signals, video, executable software code, a digital photograph, or a hyperlink.

25. The method of claim 21, where the online advertising campaign is a keyword based campaign and the template data includes a plurality of ad groups, each ad group including a bid amount, advertising content and targeting criteria comprising a set of one or more keywords.

26. The method of claim 21, where the online advertising campaign is a site based campaign and the template data includes a plurality of ad groups, each ad group including a bid amount, advertising content and targeting criteria comprising a set of one or more universal resource locators (URLs) for one or more web sites targeted for ad placement.

27. The method of claim 21, where:
the advertising campaign template further comprises a set of one or more rules provided by the first entity defining limitations on modifications to the advertising content by the second entity.

28. The method of claim 21, where the template data further includes budget information.

29. A system for generating an online advertising campaign comprising:
a user interface configured to receive template data from a first user, the template data including advertising content and targeting criteria;
means for providing the advertising campaign template to a second user;
means for receiving customization data from the second user, the customization data including information specific to the online advertising campaign being generated; and
means for generating:
an advertising campaign template based on the template data; and
an online advertising campaign for the second user based on the advertising campaign template and the customization data.

30. The system of claim 29, where the targeting criteria comprises at least one of a keyword or a target web site address.

31. The system of claim 29, where the template data further comprises bid information.

32. The system of claim 29, where the advertising content comprises at least one of the following: text, a graphic, audio signals, video, a digital photograph, or a hyperlink.

33. The system of claim 29, where the online advertising campaign is a keyword based campaign and the template data includes a plurality of ad groups, each ad group including a bid amount, advertising content and a set of one or more keywords.

34. The system of claim 29, where the online advertising campaign is a site based campaign and the template data includes a plurality of ad groups, each ad group including a bid amount, advertising content and targeting criteria comprising a set of one or more universal resource locators (URLs) for one or more web sites targeted for ad placement.

35. The system of claim 29, where:
the advertising campaign template further comprises a set of one or more rules provided by the first user defining limitations on modifications to the advertising content by the second user.

36. The system of claim 29, where the user interface is further configured to:
receive a list identifying one or more users authorized to be provided the advertising campaign template, the list including an identification of the second user.
